(19) United States
(12) Patent Application Publication
(10) Pub. No.: US 2014/0073316 A1
(43) Pub. Date: Mar. 13, 2014

(54) METHOD FOR INTERFERENCE & CONGESTION DETECTION WITH MULTIPLE RADIO TECHNOLOGIES

(71) Applicant: Kabushiki Kaisha Toshiba, Minato-ku (JP)

(72) Inventor: Timothy David FARNHAM, Bristol (GB)

(73) Assignee: Kabushiki Kaisha Toshiba, Minato-ku (JP)

(21) Appl. No.: 14/023,908

(22) Filed: Sep. 11, 2013

(30) Foreign Application Priority Data
Sep. 12, 2012 (GB) 1216275.6

(51) Int. Cl. H04W 24/08

(52) U.S. Cl. CPC H04W 24/08
USPC 455/423

(57) ABSTRACT

A method for distinguishing between interference and congestion in a wireless communication channel between a base station and a terminal comprising measuring, for each one of a plurality of time intervals, a set of parameters of network traffic between the base station and terminal, and determining an extent to which the respective sets are correlated with one another. The method further includes determining whether the communication channel is experiencing interference or congestion based on the extent of correlation between the sets of parameters.

### FIELD

Embodiments described herein relate to methods and systems for distinguishing between interference and congestion in a wireless communication channel between a base station and a terminal.

### BACKGROUND

Femto-cells are defined as small short range radio base stations that can be deployed without preplanning and which support a degree of self-management functions in order that they can configure and adapt to the environment. Self-management functions include dynamic configuration and optimisation, which can consist of frequency and Radio Access Technology (RAT) selection or tuning as well as triggering of handover or off-loading of traffic. Optionally, the femto-cells can also support self-healing and diagnostics capabilities.

Normally, femto-cells will report performance measurements and failure events to a management server, which can provision the default femto-cell configuration. However, for dynamic configuration changes this RRM approach is not scalable and so the individual femto-cells must make decisions on their own or in cooperation with other femto-cells. Examples of such decisions include whether or not to change RAT, frequency band, or power level, or to enter into an interference mitigation mode, as well as when and how to cooperate with their neighbours.

Typically, neighbouring femto-cells will need to co-operate in resource usage when there is a risk of interference occurring between them. Interference can arise, for example, as a result of two or more femto-cells utilising RATs that share the same radio resources (e.g. frequency bands) within the same locality. There is often insufficient radio resource available to allocate separate, non-overlapping RATs/frequency bands to different femto-cells within the same geographic area. Indeed, the move towards more efficient use of radio resource and rapid ad-hoc deployment of indoor femto-cells makes such allocation of separate RATs unattractive due to the lack of knowledge about exact location and propagation environment.

The fact that there is interference present in a communication channel may become apparent through degradation in the channel performance. However, a problem arises, in that distinguishing between interference and congestion in a communication channel is non-trivial (especially with multiple radio technologies). The reason for this is that, in both cases, the normal performance measurements dynamically vary, albeit for different reasons. For instance, frame errors and timeouts can be caused by congestion as well as interference. Therefore, it may be difficult for a femto-cell to determine whether a reduction in performance is due to interference (and so requires cooperation with neighbouring femto-cells) or whether it is due to congestion (in which case, cooperation with other femto-cells may not be needed). The problem is particularly acute when the network traffic itself is bursty and unpredictable.

Conventional approaches for distinguishing between interference and congestion in femto-cell networks involve measuring one or more parameters of the communication channel between the femto-cell and a respective terminal, and determining whether these parameters are above a threshold. Such parameters include, for example, cell loading, transmission errors and transmission timeouts. The thresholds can be used to define a point at which to perform a handover, change RAT or increase/reduce transmit power, for example.

Importantly, the thresholds themselves may be specific to certain RATs. Consequently, where multiple RATs are supported, it will be necessary to compute separate thresholds for each RAT, with the thresholds being mapped from the associated application requirements. Although Self Organising Network (SON) principles can adjust the thresholds in an autonomous manner, mapping of thresholds is still complex when there are many RATs involved, and the process is prone to translation problems. Moreover, crossings and false detection rate will be high and typically have to be filtered by simply counting the number of threshold crossing events in a time period.

Whilst interference coordination approaches exist in standards (such as 3GPP LTE—see 3GPP TS36.213), these are devised for large macro-cell single RAT deployments and are not easily implemented in low-cost femto-cell deployments where the backhaul is often over ADSL broadband connection. For instance, the 3GPP LTE standard specifies an X2 interface (3GPP TS36.423) that supports interference indication signals (such as the high interference or overload indicators) between base-stations, but this is not included in the standard for femto-cell base-stations (known as HeNB). Also, the way in which the binary flags within these signals are interpreted by the recipients and the frequency of sending the signals is not defined in the standard, which introduces ambiguity. Therefore, in this case it is not possible to reliably signal interference indications to neighbouring femto-cells. Further it is not possible to signal between different RATs (such as LTE and WiMAX femto-cells).

It follows that there is a need to provide an improved means for locally distinguishing between interference and congestion in femto-cell communication networks.

### BRIEF DESCRIPTION OF FIGURES

FIG. 1 shows a schematic of two base stations having overlapping areas of coverage which suffer interference from one another as a result;

FIG. 2 shows a conventional method for distinguishing between interference and congestion in a communication channel between a base station and a terminal;

FIG. 3 shows a schematic of how separate thresholds must be calculated for different RATs when using the conventional method shown in FIG. 2;

FIG. 4 shows a method for distinguishing between interference and congestion in a communication channel between a base station and a terminal, in accordance with an embodiment described herein;

FIG. 5 is a schematic illustration of how described embodiments obviate the need to calculate separate thresholds for different RATs;

FIG. 6 shows a schematic of how different parameters of network traffic between a base station and a terminal are measured and grouped into sets in accordance with a described embodiment;

FIG. 7 shows results of a simulation indicating how delivery performance (in terms of latency distribution) for different loading levels is improved using a method according to a described embodiment; and

FIG. 8 shows results of a simulation indicating how the probability of successfully distinguishing between interference and congestion in a wireless communication channel varies as a function of the entropy threshold, the number of measurement samples (N) and the ordering of the samples when using a method according to a described embodiment.

### DETAILED DESCRIPTION

A first embodiment provides a method for distinguishing between interference and congestion in a wireless communication channel between a base station and a terminal, comprising:
measuring, for each one of a plurality of time intervals, a set of parameters of network traffic between the base station and terminal;
determining an extent to which the respective sets of parameters are correlated with one another; and
determining whether the communication channel is experiencing interference or congestion based on the extent of correlation between the sets of parameters.

In some embodiments, the method may comprise quantifying the extent of correlation using a correlation parameter, and determining whether the communication channel is experiencing interference or congestion based on whether or not the correlation parameter is above or below a threshold.

In some embodiments, the method may further comprise using the value of the correlation parameter to decide whether or not to handover communication from the base station to another base station.

In some embodiments, each set of measured parameters may be used to define a respective vector. The step of determining an extent to which the respective parameters are correlated with one another may comprise performing a cluster analysis of the respective vectors.

In some embodiments, the cluster analysis may comprise defining one or more cluster centres, and determining the distance of each vector from each cluster centre.

In some embodiments, the step of performing a cluster analysis may comprise:
i) specifying a number of cluster centres to be used in the analysis;
ii) initialising a membership matrix;
iii) using the vectors and values in the membership matrix to calculate the location of each cluster centre;
iv) recomputing the values of the membership matrix, such that the values in the membership matrix indicate the distance of each vector from the respective cluster centres;
v) using the recomputed membership matrix to calculate an objective function;
vi) repeating steps iii) to v) to minimise the objective function; and
vii) using the final calculated values of the membership matrix to determine the correlation parameter.

In some embodiments, the number of cluster centres is specified to be 2.

In some embodiments, the measured parameters may include two or more of frame errors, timeout, received signal level, and cell loading.

A second embodiment provides a cellular base station for communicating information to one or more terminals over a communication channel, the base station being configured to carry out a method according to the first embodiment.

A third embodiment provides a terminal station for receiving information transmitted from a base station over a communication channel, the terminal being configured to carry out a method according to the first embodiment.

A fourth embodiment provides a computer readable storage medium comprising computer readable code that when executed by a computer will cause the computer to carry out a method according to the first embodiment.

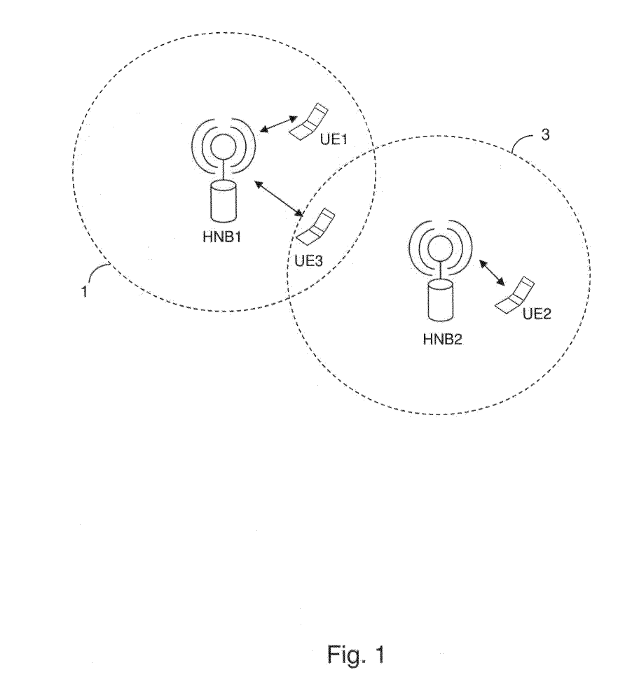

FIG. 1 shows an example of a pair of base stations HNB1 and HNB2 that share network resources to communicate with a plurality of user devices. Each base station has its own respective area of coverage 1, 3, as shown by the circular dashed lines. In this example, HNB1 communicates with a first user device UE1 located within its area of coverage. Similarly, HNB2 communicates with a second user device UE2 located within its own area of coverage.

In addition to communicating with UE1, HNB1 also communicates with a third user device UE3. The third user device is located in a region of overlap between the two femto-cells' areas of coverage. Since UE3 is within range of both HNB1 and HNB2, it is possible that the UE3 may experience interference from HNB2, even though it is only intended for HNB1 to communicate with UE3. Therefore, in the event that degradation occurs in the communication channel between HNB1 and UE3, it will be necessary for HNB1 to determine whether this degradation is due to congestion, or interference from HNB2.

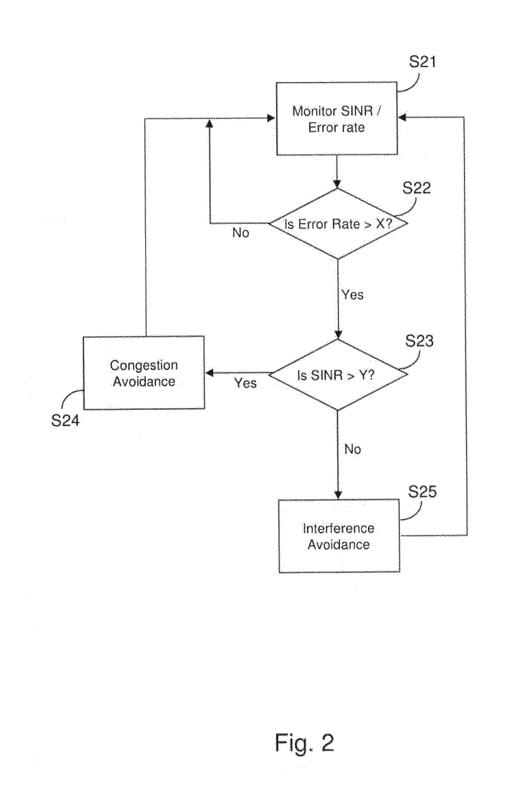

Conventional methods of classifying degradation as being caused by interference or congestion rely on measuring specific parameters of the communication channel and determining whether these lie above or below a threshold. An example is shown in FIG. 2, which shows a flow chart for determining whether to proceed with congestion or interference avoidance at the base station. In step S21, measurements are made of SINR and error rate for the communication channel in question. If the error rate is found to be below a first threshold X (step S22), the sequence returns to step S21. If the error rate is above the threshold X, the sequence progresses to step S23, in which the SINR is compared against a second threshold Y. Where the SINR is determined to be above the threshold Y, a decision is made that the increased error rate is due to congestion and the base station responds accordingly (step S24). If the SINR is found to be below the threshold Y, a decision is made that the increased error rate is due to interference from other station(s) in the vicinity. The base station then implements a protocol for interference avoidance (step S25). In both cases, the method then returns to step S21.

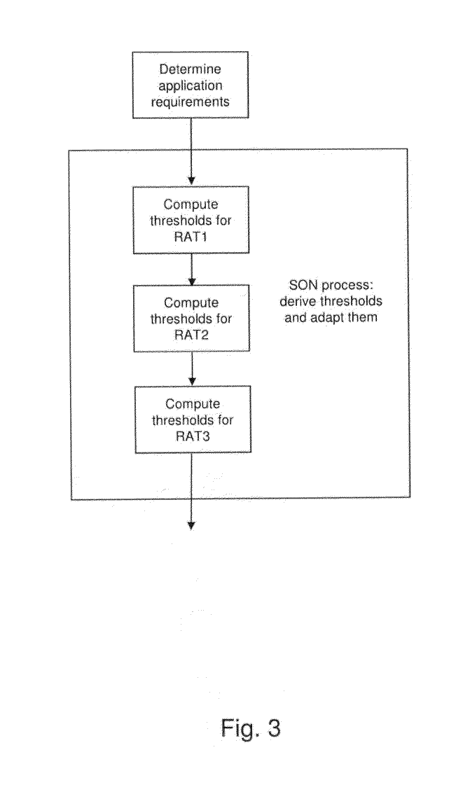

A problem that arises in the conventional approach described above is that measurements are technology specific and vary dynamically depending on how they are defined; the thresholds have to be computed for each radio access technology and must be mapped from the associated application requirements. This is shown schematically in FIG. 3.

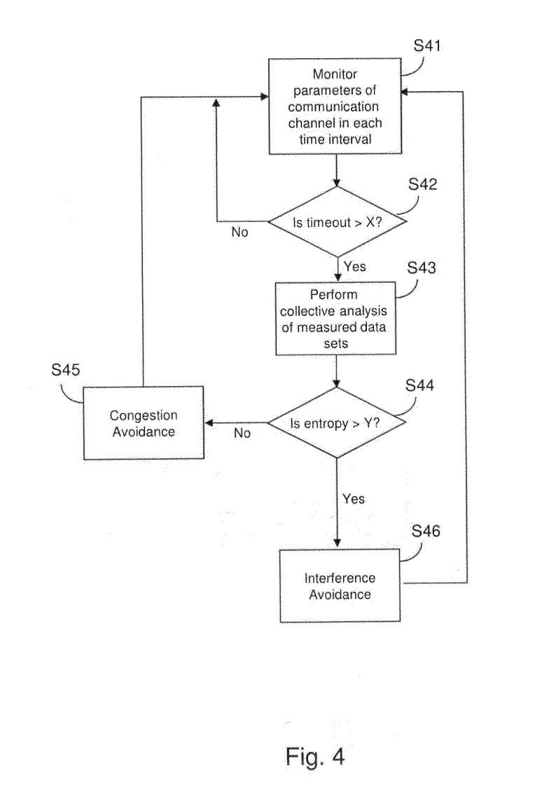

A method of classifying the cause of degradation as used in an embodiment is shown schematically in FIG. 4. The method begins by monitoring various parameters of the communication channel (e.g. frame errors, received signal level, cell loading, etc) over a series of discrete time intervals. A trigger based on generic timeout (X) is used to determine when degradation in the communication channel is severe enough to justify proceeding with further analysis of the measured parameters (step S42). When the time-out is found to exceed a threshold, the method proceeds to step S43. Here, the respective sets of parameters measured in each time interval are collectively analysed in order to determine the extent of correlation between them. The analysis concludes by calculating an entropy value which measures how well the data vectors (i.e. the respective parameter sets) are correlated with one another. If the entropy value is below a threshold Y, then it is possible to explain the performance degradation within the respective measurement data sets (i.e. based on the traffic pattern), meaning congestion avoidance is appropriate (Step 45). Conversely, if the entropy value is above the threshold Y, this indicates that the performance degradation arises from interference from neighbouring base stations, and interference avoidance is therefore an appropriate response (S46).

The main structural difference between the described embodiments and the approach shown in FIG. 2 is that rather than placing absolute and radio technology specific thresholds on the individual dynamic measurements, such as a SINR threshold to trigger a corresponding action, these embodiments seek to determine correlations between the groups of parameters measured in each interval in order to derive a generic threshold or “entropy” measurement that is not specific to a particular radio technology or attribute. Instead, the entropy measurement specifies a degree of correlation between basic technology specific measurements and so abstracts away from the specific values and their interpretation.

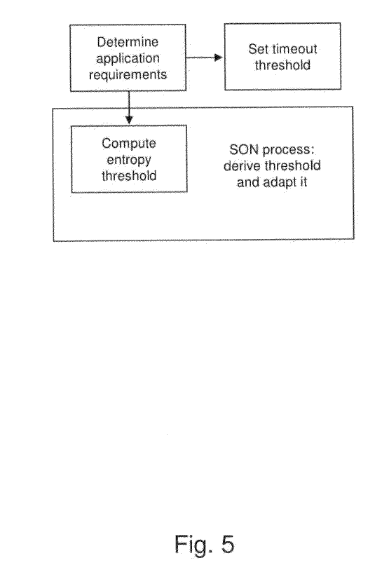

The entropy not only determines how well correlated the sets of measurements are, but can also help to explain the reason for variation in the underlying performance parameters. Calculating the entropy has the advantage that it obviates the need for thresholds on technology specific measurements such as SINR, which requires technology specific mapping. This is shown schematically in FIG. 5.

Embodiments may combine measurements obtained locally and then signal interference or congestion notifications in a generic manner using layer 3 (RAT independent) approaches. Some embodiments may use clustering of the sets of parameters measured in each time interval to determine a correlation between those sets. Doing so can provide a better insight into the causes of the variations in the individual parameters, and can obviate the difficulty in obtaining and mapping a suitable set of threshold criteria for reliable detection of interference and congestion.

In some embodiments, a fuzzy c-means clustering algorithm may be used to determine the extent of correlation between the measured sets of parameters. Fuzzy clustering algorithms have been used in the past for purposes such as pattern recognition in images, machine learning and more recently for real time data stream mining, and offers a suitable candidate for identify interference in femto-cell environments, providing it can rapidly and reliably detect the dynamic changes in the performance characteristics.

Where clustering is used, the proposed approach may use local measurements such as load, error rate, signal level and frame delivery timeouts and cluster them in order to derive a generic entropy measure that is more reliable and simpler to map to different radio technologies. In practical applications, this approach can achieve resource utilisation efficiency gains in multi-RAT (so-called heterogeneous) radio scenarios. The number of mappings that need to be performed is minimised and thus the signalling overhead and complexity of supporting multiple RAT deployments is reduced.

To perform clustering of the measurements in real time, a sliding window is used that consists of the last N measurement intervals. Measurements are taken at discrete time intervals and N samples are clustered for each UE to femto-cell UL connection separately. The clustering can be performed either in the UE or the femto-cell access point, and can be continuously updated (or on demand).

The measurements that are taken may be frame errors (CRC check failure), timeout (assuming a fixed latency threshold), received signal level and/or cell loading.

Individually these measures are not sufficient to determine the cause of performance degradation, and thresholds on each individual attribute need careful consideration and mapping (in a RAT dependent manner), as they do not uniquely identify why performance varies. For instance, interference will cause timeout and frame errors to increase, but this can also occur if there is signal fading or congestion. The clustering approach enables correlation between the different measurements to determine whether the degradation is caused by cell load (congestion) or interference from neighbouring femto-cells.

It is important to make a reliable assessment in order to determine the best course of action. For instance, if the degradation is caused by interference the best action could be to signal to the neighbouring femto-cells to determine if the interfering UE can initiate a handover to another RAT (or RAT mode of operation). Conversely, if the degradation is caused by congestion on the femto-cell, it is necessary to consider the handover of the UE on the local femto-cell (i.e. to another RAT).

In more detail, embodiments may include the following steps:
Detect performance degradation (if using on-demand trigger based approach otherwise trigger recalculation periodically)
Perform clustering of last N measurements sets obtained
Compare cluster partition entropy with a threshold to determine whether degradation is caused by interference

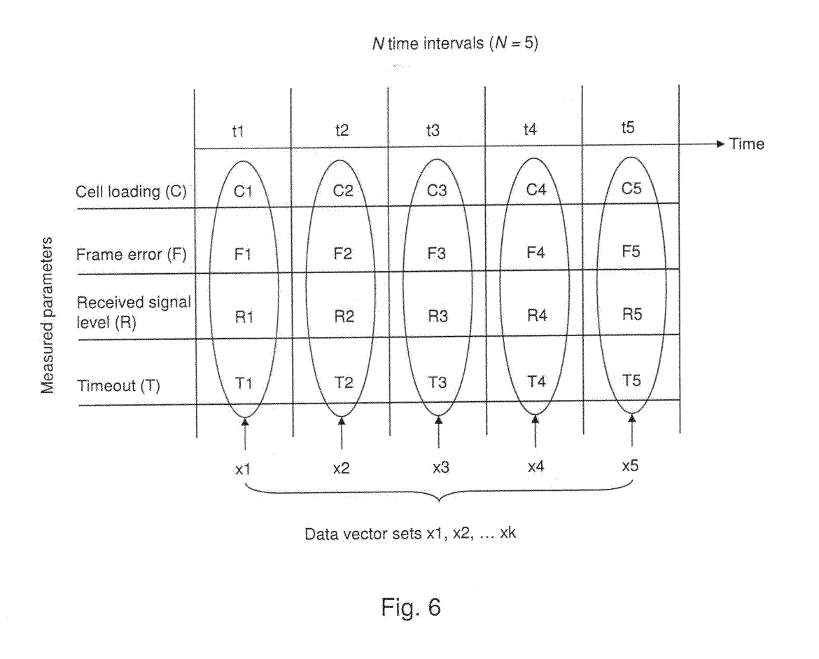

The clustering step involves an iterative process for determining the extent to which the sets of measured parameters in each time interval are correlated with one another. Referring to FIG. 6 measurements of different network parameters (for example, cell loading C, frame error F, received signal level R, and timeout T) are taken in a plurality of N time windows. In each time window, the set of measured parameters are grouped together to form a respective vector Xₖ, where X={x₁, x₂, x₃, . . . x_{N}}. (Here the values C, T, F and R shown in FIG. 6 are mapped into the X matrix based on the fact that Xₖ is a four (or more) dimensional vector—in other words, in the example shown in FIG. 6, xₖ has 4 coordinates in Euclidean space defined in terms of C, T, F and R values). The C, T, F and R values are normalised so that they have the same basis (for instance they are all lie in the range 0 . . . 1), and hence xₖ=(Cₖ, Tₖ, Fₖ, Rₖ) in Euclidean coordinates.

A clustering algorithm then takes the data vector set X={x₁, x₂, x₃, . . . x_{N}} and partitions it into c clusters, such that an objective function is minimised.

The algorithm begins by selecting an initial random cluster membership matrix (U) where, for all values of k (1 . . . N):

$${\sum }_{i = 1}^{n} {u}_{ik} = 1 \qquad ( Equation 1 )$$

Following this, the initial cluster centres vᵢ are computed using Equation 2:

$${v}_{i } = \frac{{\sum }_{k = 1}^{N} {( {u}_{ik} )}^{m} {x}_{k}}{{\sum }_{k = 1}^{N} {( {u}_{ik} )}^{m}} \\ i = 1 , 2 , … , c \qquad ( Equation 2 )$$

where c is the total number of clusters and uᵢₖ is the value of the membership matrix that relates the vector xₖ to a particular cluster i. The parameter m is a tuning parameter that can be used to speed up or slow down convergence (m>1).

Having derived the cluster centres, the values of the membership matrix U are now recomputed using Equation 3:

$${u}_{ik} = \frac{1}{{\sum }_{j = 1}^{c} {( \frac{{d}_{ik}}{{d}_{jk}} )}^{2 / ( m - 1 )}} \\ i = 1 , 2 , … , c and {k = 1 , 2 ,}_{25} … , N \qquad ( Equation 3 )$$

Here dᵢₖ=∥xₖ₋vᵢ∥ is the Euclidean distance between data vector Xₖ and the respective cluster centroid vᵢ. The values dⱼₖ=∥Xₖ₋vⱼ∥ represent the Euclidean distance between the data vector Xₖ and each one the cluster centres vⱼ, where j=1, 2, . . . c. The result of performing the calculation shown in Equation 3 is to provide updated values uᵢₖ for each vector Xₖ, where each value uᵢₖ is inversely proportional to the sum of relative distances that the vector Xₖ is from the respective cluster centre vᵢ compared to each one of the other cluster centres vⱼ.

The objective function J (U, v) is then calculated as follows:

$$I ( U , v ) = {\sum }_{k = 1}^{N} {\sum }_{i = i}^{c} {( {u}_{ik} )}^{m} {( {d}_{ik} )}^{2} \qquad ( Equation 4 )$$

After calculating the objective function, the cluster centres vᵢ are now re-computed by inserting the present values of uᵢₖ back into Equation 2. Once the cluster centres vᵢ have been re-computed, the values uᵢₖ are updated using Equation 3, and the objective function calculated once more. The process repeats itself iteratively until either the maximum iterations (R) is reached or the maximum difference between objective function values, from the previous iteration, is less than a threshold amount (α).

In essence, the objective function minimisation comprises calculating the sum of the distances from each vector xₖ to each candidate cluster centre, weighted by the corresponding cluster membership value for the latest cluster centre estimate vᵢ values, which are also then updated after each iteration.

Using this fuzzy clustering technique enables the quality of the clustering to be assessed in terms of different validity parameters. For instance, the partition coefficient measures the closeness of all the input data vectors to the corresponding cluster centres. The partition entropy measures how well the data vectors fit into the corresponding clusters based on the closeness of the membership values to either 1 or 0.

The formal definition of partition entropy is:

$$H ( U , v ) = - \frac{1}{N} {\sum }_{i = 1}^{c} {\sum }_{k = i}^{N} {u}_{ik} log ( {u}_{ik} ) \qquad ( Equation 5 )$$

In some embodiments, to determine how correlated the measurement set values are and whether there is an additional reason for performance degradation other than known causes, the number of cluster centres is specified as 2 (i.e. c=2 in Equations 2-4) and the partition entropy is calculated in order to assess how fuzzy the resulting clusters are. Low entropy indicates that the performance degradation can be explained within the measurement data set (i.e. performance degradation arises from the local measurement variations within the same base station cell). Conversely, a high entropy suggests that the performance degradation is due to interference from neighbouring base station cells.

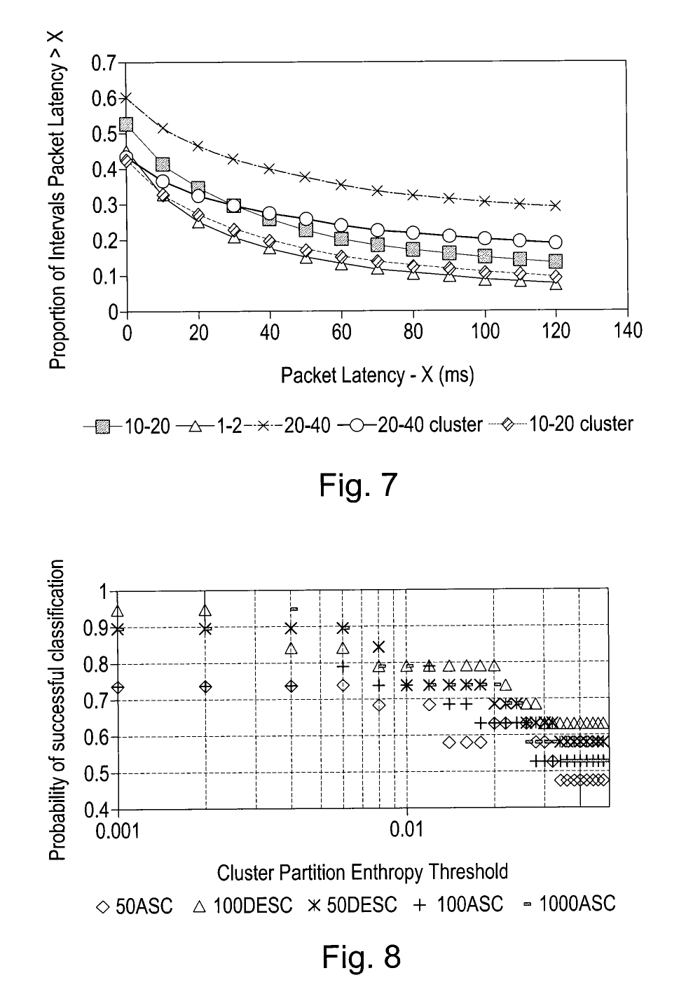

FIG. 7 shows the results of a simulation indicating that a clustering approach with entropy computation can improve the delivery performance by around 10% at a 100 ms latency target. The results shown in FIG. 7 are compiled by considering the delivery of data units (packets) within a target time period (latency), which is a useful measure to determine performance for latency sensitive traffic. The traffic is assumed to be bursty in nature, determined by a Markov Modulated Poisson Process (MMPP), and assumes that four RAT modes can be selected based on a single threshold placed on the entropy value obtained from clustering the frame latency, error rate, signal level and load. The scenario assumes six access points and twelve terminals in a dense deployment. This is due to the reliability of being able to determine the difference between interference and congestion. In this simulation, the clustering approach is applied to the data sets of N samples, where N is 50, 100 or 1000, collected with both increasing (ASC) and decreasing (DESC) time order (corresponding to oldest-newest and newest-oldest orders, respectively) while the UE activity is increased. For clustering purposes the value of R used is 1000, α is set to 0.05 and m of 1.2 is used.

The results in FIG. 8 show how by performing clustering in three dimensions, using the normalised same femto-cell loading, timeout probability and frame error probability measurements, it is possible to determine whether these measures are correlated and thus explain the variations. As a result, it is possible to determine whether there is congestion or interference for a particular UE, based on a simple fixed partition entropy threshold.

The clustering may be performed over a subset of the successive time intervals (N). The results shown in FIG. 8 indicate that it is possible to obtain higher reliability than a single threshold even with small data sets (i.e. N<100). As expected, when the UE activity is higher, meaning it is more likely to be within a high load state, the classification reliability improves with N and more reliable determination is possible when the measurement time order is descending (DESC) from a newest to oldest rather than the other way round. This means that it is possible to gain a better reliability in estimation if it is likely that the UE (and also the adjacent cell UE) are within high activity states.

Embodiments described herein may be carried out at one of several locations in a cellular network. For example, clustering analysis may be performed in a terminal (such as in a JRRM-T as per ETSI RRS or the TRM as in IEEE1900.4) in which local RAT measurements are used. In another approach, the clustering may be performed on the network side (such as within the JRRM-N as per ETSI RRS or the NRM as in IEEE1900.4) which can, for instance, reside within a femto-cell access point or a core network. The measurements are all obtained from the femto-cell/terminal and are clustered to determine the entropy values and these can be sent back as an interference/congestion severity level or as policies (as per IEEE 1900.4).

While certain embodiments have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A method for distinguishing between interference and congestion in a wireless communication channel between a base station and a terminal, comprising:
measuring, for each one of a plurality of time intervals, a set of parameters of network traffic between the base station and terminal;
determining an extent to which the respective sets of parameters are correlated with one another; and
determining whether the communication channel is experiencing interference or congestion based on the extent of correlation between the sets of parameters.

2. A method according to claim 1 comprising quantifying the extent of correlation using a correlation parameter, and determining whether the communication channel is experiencing interference or congestion based on whether or not the correlation parameter is above or below a threshold.

3. A method according to claim 2 comprising using the value of the correlation parameter to decide whether or not to handover communication from the base station to another base station.

4. A method according to claim 1, wherein each set of measured parameters is used to define a respective vector; and the step of collectively analysing the sets of measured parameters comprises performing a cluster analysis of the respective vectors.

5. A method according to claim 4, wherein the cluster analysis comprises defining one or more cluster centres, and determining the distance of each vector from each cluster centre.

6. A method according to claim 5, wherein performing a cluster analysis comprises:
i) specifying a number of cluster centres to be used in the analysis;
ii) initialising a membership matrix;
iii) using the vectors and values in the membership matrix to calculate the location of each cluster centre;
iv) recomputing the values of the membership matrix, such that the values in the membership matrix indicate the distance of each vector from the respective cluster centres;
v) using the recomputed membership matrix to calculate an objective function;
vi) repeating steps iii) to v) to minimise the objective function; and
vii) using the final calculated values of the membership matrix to determine the correlation parameter.

7. A method according to claim 5, wherein the number of cluster centres is specified to be 2.

8. A method according to claim 1, wherein the measured parameters include two or more of frame errors, timeout, received signal level, and cell loading.

9. A cellular base station for communicating information to one or more terminals over a wireless communication channel, the base station being configured to carry out a method according to claim 1.

10. A terminal station for receiving information transmitted from a base station over a wireless communication channel, the terminal being configured to carry out a method according to claim 1.

11. A non-transitory computer readable storage medium comprising computer readable code that when executed by a computer processor will cause the processor to carry out a method according to claim 1.

12. A method according to claim 6, wherein the number of cluster centres is specified to be 2.

13. A non-transitory computer readable storage medium comprising computer readable code that when executed by a computer processor will cause the processor to carry out a method according to claim 2.

14. A non-transitory computer readable storage medium comprising computer readable code that when executed by a computer processor will cause the processor to carry out a method according to claim 3.

15. A non-transitory computer readable storage medium comprising computer readable code that when executed by a computer processor will cause the processor to carry out a method according to claim 4

16. A non-transitory computer readable storage medium comprising computer readable code that when executed by a computer processor will cause the processor to carry out a method according to claim 5.

17. A non-transitory computer readable storage medium comprising computer readable code that when executed by a computer processor will cause the processor to carry out a method according to claim 6.

18. A non-transitory computer readable storage medium comprising computer readable code that when executed by a computer processor will cause the processor to carry out a method according to claim 7.

19. A non-transitory computer readable storage medium comprising computer readable code that when executed by a computer processor will cause the processor to carry out a method according to claim 8.
